(19) United States
(12) Patent Application Publication
(10) Pub. No.: US 2018/0333872 A1
(43) Pub. Date: Nov. 22, 2018

(54) BLADE WITH ROUNDED CONTACT SURFACE

(71) Applicant: Richard W. Thorin, Houston, TX (US)

(72) Inventor: Richard W. Thorin, Houston, TX (US)

(21) Appl. No.: 16/049,616

(22) Filed: Jul. 30, 2018

Related U.S. Application Data
(63) Continuation-in-part of application No. 12/911,619, filed on Oct. 25, 2010, now abandoned.
(60) Provisional application No. 61/258,777, filed on Nov. 6, 2009.

(51) Int. Cl. B26B 9/02

(52) U.S. Cl. CPC B26B 9/02

(57) ABSTRACT

A blade for cutting food products, wherein the blade can have an upper blade portion having a uniform first thickness, a contact portion disposed on the upper blade portion having a second thickness greater than the first thickness, and a cutting surface disposed on the contact portion. The cutting surface can comprise an arc of a circle from 1 degree to 180 degrees to provide a safe cutting surface shape.

### CROSS REFERENCE TO RELATED APPLICATIONS

The present application is a Continuation in Part and claims the benefit and priority to co-pending U.S. patent application Ser. No. 12/911,619 filed on Oct. 25, 2010, entitled “Food Product Blade With Minimal Contact Surface and Method of Use”, which in turn claims priority to U.S. Provisional Patent Application Ser. No. 61/258,777 filed on Nov. 6, 2009, entitled “A cheese cutlery and soft process food blade, requires less pressure to cut or slice products, and is safe in that it is not sharp and one cannot cut themselves with the unit”, which are incorporated herein in their entirety.

### FIELD

The present embodiments generally relate to an apparatus including a blade configured to slice food products with a minimal friction path providing ease in cutting and preventing the food products from sticking on the blade.

### BACKGROUND

A need exists for a simple, safe, and inexpensive blade configured to slice food products that can provide full slicing penetration through the food products.

A need exists for a blade configured to slice food products with a minimal friction path providing ease in cutting and preventing the food products from sticking on the blade.

A further need exists for a blade for slicing food products that has a non-sharp cutting surface preventing and/or reducing the occurrence of user injuries and marring of cutting surfaces.

The present embodiments meet these needs.

### BRIEF DESCRIPTION OF THE DRAWINGS

The detailed description will be better understood in conjunction with the accompanying drawings as follows:

FIG. 1 depicts a blade according to one or more embodiments.

FIG. 2 depicts an end view of the blade according to one or more embodiments.

FIG. 3 depicts the blade with a frame and a handle according to one or more embodiments.

FIG. 4 depicts an end view of the blade with the frame and the handle according to one or more embodiments.

FIG. 5 depicts the blade while slicing a food product according to one or more embodiments.

The present embodiments are detailed below with reference to the listed Figures.

### DETAILED DESCRIPTION OF THE EMBODIMENTS

Before explaining the present disclosure in detail, it is to be understood that the disclosure is not limited to the specifics of particular embodiments as described and that it can be practiced, constructed, or carried out in various ways.

While embodiments of the disclosure have been shown and described, modifications thereof can be made by one skilled in the art without departing from the spirit and teachings of the disclosure. The embodiments described herein are exemplary only and are not intended to be limiting.

Specific structural and functional details disclosed herein are not to be interpreted as limiting, but merely as a basis of the claims and as a representative basis for teaching persons having ordinary skill in the art to variously employ the present embodiments. Many variations and modifications of embodiments disclosed herein are possible and are within the scope of the present disclosure.

Where numerical ranges or limitations are expressly stated, such express ranges or limitations should be understood to include iterative ranges or limitations of like magnitude falling within the expressly stated ranges or limitations.

The use of the word “a” or “an” when used in conjunction with the term “comprising” in the claims and/or the specification may mean “one,” but it is also consistent with the meaning of “one or more,” “at least one,” and “one or more than one.”

The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description herein, but is only limited by the claims which follow, encompassing all equivalents of the subject matter of the claims. Each and every claim is hereby incorporated into the specification as an embodiment of the present disclosure. Thus, the claims are a further description and are an addition to the embodiments of the present disclosure.

The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

The present embodiments relate to a multi-purpose apparatus with a blade configured to slice food products with a minimal friction path providing ease in cutting and preventing the food products from sticking on the blade. The blade described herein can be used to slice a variety of food products including but not limited to: cheese, such as block cheese, soft process foods, soft fruits, and other soft food products. The blade can be utilized to cut and/or slice both refrigerated and non-refrigerated food products.

In one or more embodiments, the blade can be rigid allowing the blade to slice through food products without stretching and/or breaking. In one or more embodiments, the rigid characteristic of the blade can allow the blade to fully slice through a food product, from a first surface of the food product to a second surface of the food product, without stretching the food product; and therefore, without leaving an uncut portion of the food product.

The apparatus, also referred to herein as a knife, can include a blade with a cutting surface configured to cut food products, a contact surface configured to contact the cut food products, and an upper blade portion that is thinner than the contact surface, such that the upper blade portion is configured to be spaced apart from the food products as the food products are being cut and/or sliced. The apparatus can also include a frame and a handle. The apparatus can be configured and sized to fit safely within common house ware drawers.

In one or more embodiments, the blade can be formed or made from an extrusion and hot or cold rolled process to provide an effective shape for the blade. The apparatus can be made of stainless steel, such as 316 stainless steel. In one or more embodiments, the blade can be 5/16^{th} of an inch in height with a cutting surface of 1/16^{th} in height. In one or more embodiments, the blade can be straight and configured to have a maximum deviation from straightness of 0.030 inches per foot. The deviation from straightness can be determined by visual inspection and random measurements of the straightness of the blade. In one or more embodiments, surface areas, edges, and corners of the apparatus can have a maximum average roughness of 63 micro-inches. The blade can be other sizes, have other dimensions, and be made of other materials depending upon the particular application.

In one or more embodiments, the frame and the handle can be made of a continuous piece of ¼^{th} inch stainless steel rod having continual bends therein to form the handle and the frame. The handle and frame can support the blade. In one or more embodiments, the blade can be welded to the frame to provide stability and strength to the apparatus. In one or more embodiments, the apparatus can be made using plastics extrusion and/or molding. The frame and the handle can be other sizes, can have other dimensions, and be made of other materials depending upon the particular application.

In one or more embodiments, the blade can be attached to a frame, such as a U-shaped frame, C-shaped frame, or another shaped frame. The frame can be attached to a cutting board. The cutting board can be made of wood, plastic, or any other suitable material. The blade can then be used to slice food products, such as cheese, that are placed on the cutting board.

One or more embodiments relate to a method for cutting a food product. The method can include engaging the cutting surface of the blade with a top surface of a food product.

The method can include applying a force to the cutting surface to traverse the cutting surface through the food product from the top surface of the food product to a bottom surface of the food product to form cut portions of the food product.

The method can include contacting the contact portion of the blade with the cut portions of the food product while applying the force to the cutting surface.

The method can include maintaining a spaced apart relationship between the upper blade portion of the blade and the cut portions of the food product.

The blade can comprise three main components: an upper blade portion, a contact portion, and a cutting surface.

The upper blade portion can provide rigidity to the contact portion and the cutting surface. The upper blade portion can be of substantially uniform thickness. The thickness can be determined by persons having ordinary skill in the art based upon the material being cut, such that there is minimal flexion of the blade, contact portion, or cutting surface. In embodiments, the upper blade portion can be fixed on both ends to a frame, such that there is minimal flexion in the direction orthogonal to the blade. The plane of the upper blade portion can be the direction that the blade cuts in.

The contact portion can have a thickness greater than the thickness of the upper blade portion and stepped outward from the upper blade portion, thus minimizing friction between the blade and the material being cut.

The cutting surface can be disposed upon the contact area opposite the upper blade portion and orthogonal to the plane of the upper blade portion. The cutting surface can comprise the arc of a circle from about 1 degree to about 180 degrees. The cutting surface is configured to be pushed in the plane of the upper blade portion through the material being cut. Dragging the blade or using a sawing motion would frustrate the purpose of the present disclosure.

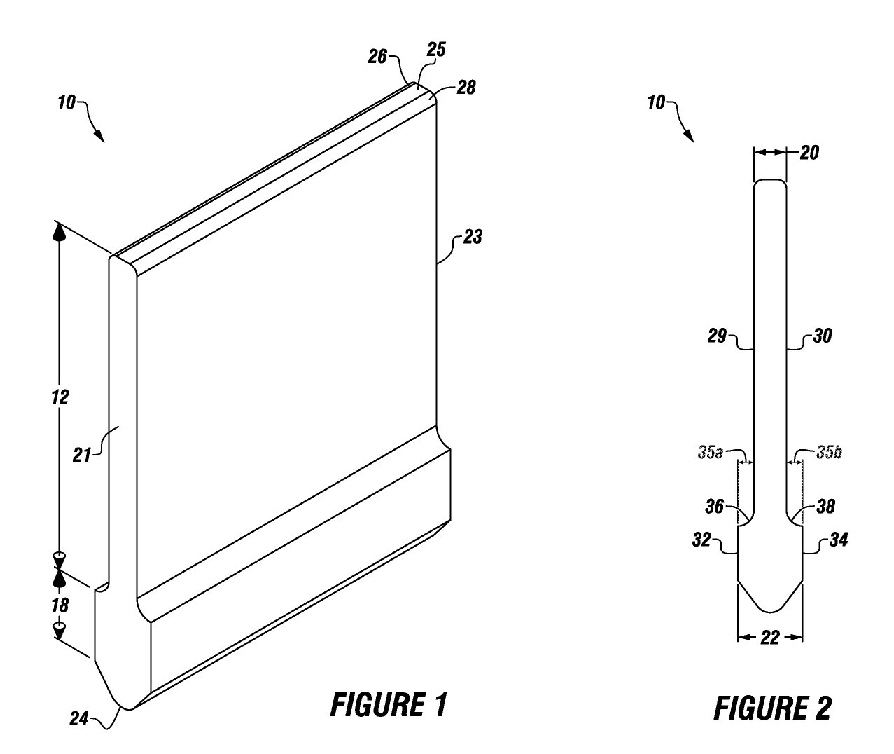

Turning now to FIG. 1, an embodiment of the blade 10 is depicted. The blade 10 can have an upper blade portion 12 and a contact portion 18 disposed on a bottom side of the upper blade portion 12. The contact portion 18 can be formed integrally with the upper blade portion 12 or can be connected thereto. The upper blade portion 12 can have a first edge 21 and a second edge 23.

A cutting surface 24 can be disposed on the contact portion 18 opposite the upper blade portion 12. The cutting surface 24 can be formed integrally with the contact portion 18 or can be connected thereto. The cutting surface 24 can be a rounded and/or a blunt surface as opposed to a sharp knife-like cutting surface. In one or more embodiments, the cutting surface 24 can be a cutting surface that does not require sharpening. The cutting surface 24 can reduce or eliminate the occurrence of sharp surface related injuries and damage, such as a user cutting the user's fingers or marring a counter or other surface with the cutting surface 24. In one or more embodiments, the cutting surface 24 can be tapered from the contact portion 18. In one or more embodiments, the cutting surface 24 can be a sharp knife-like cutting surface.

In one or more embodiments, each corner and/or edge can be blended. For example, each corner and/or edge of the apparatus can be curved and/or rounded rather than being sharp right-angled corners and/or edges. As such, the apparatus can be safer to use and can lead to less user injuries, such as cuts, scratches, and scrapes. For example, the blade 10 can include a first blended edge 26, a second blended edge 28, and a top edge 25. The first blended edge 26 can be formed at a connection between the top edge 25 and the upper blade portion 12. The second blended edge 28 can be formed at a connection between the top edge 25 and the upper blade portion 12.

FIG. 2 depicts an end view of an embodiment of the blade 10. The contact portion can have a first contact surface 32 and a second contact surface 34. Each contact surface 32 and 34 can be configured to contact food products during cutting and/or slicing of the food products. The upper blade portion can have a first upper surface 29 and a second upper surface 30. Each upper surface 29 and 30 can be disposed relative to each contact surface 32 and 34 such that each upper surface 29 and 30 can be spaced apart from the food products during the cutting and/or slicing of the food products, while the contact surfaces 32 and 34 are contacting the food products. As such, the contact surfaces 32 and 34 can function to spread the food product as the cutting surface cuts the food product, and the upper surfaces 29 and 30 can remain spaced apart from the food product. In operation, the upper surfaces 29 and 30 can provide stability to the cutting surfaces; preventing deflection of the cutting surface during cutting without coming into contact with the food product.

The first upper surface 29 can be recessed from the first contact surface 32. For example, a third blended edge 36 can be formed at a connection between the first contact surface 32 and the first upper surface 29. The second upper surface 30 can be recessed from the second contact surface 34. For example, a fourth blended edge 38 can be formed at a connection between the second contact surface 34 and the second upper surface 30.

The contact portion can be thicker than the upper blade portion. For example, a second thickness 22 of the contact portion can be larger than a first thickness 20 of the upper blade portion. The first contact surface 32 and the first upper surface 29 can be positioned stepped outwardly from the upper blade portion. The steps 35a and 35b show a discrete space formed by such a configuration of the contact surfaces. This discrete space serves to minimize contact of the item the blade is used upon with the upper blade portion, thereby reducing friction as the blade cuts through material. The steps 35a and 35b need not be the same size, providing that they form a gap to separate the upper blade portion from any materials being cut. In embodiments, features such as blended edges 36 and 38 may be necessitated due to manufacturing constraints, however, they are not material to steps 35a and 35b.

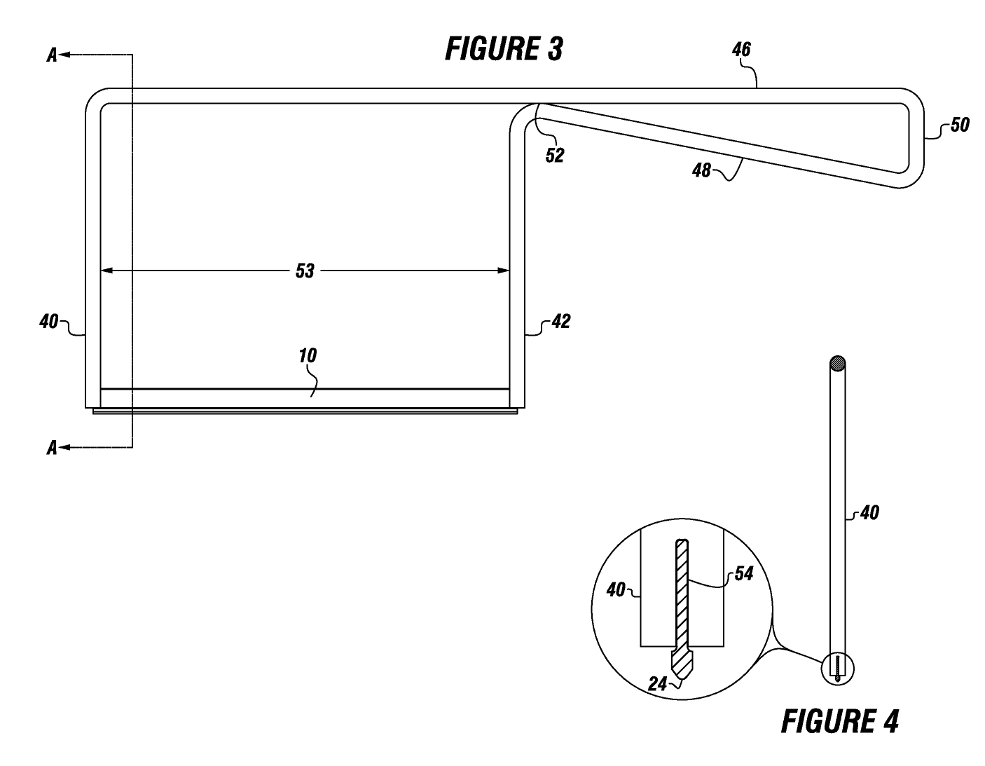

FIG. 3 depicts an embodiment of the apparatus having the blade 10. The blade 10 is attached to a frame with a first member 40, a second member 42, an upper handle portion 46, a lower handle portion 48, and a curved handle end 50, which can be a single piece construction integrally connected, or can be separate elements connected to one another. The blade 10 can be disposed in any suitable frame with any suitable handle.

The upper handle portion 46 and the lower handle portion 48 can be integrally connected or otherwise connected to each other at the curved handle end 50. The lower handle portion 48 can be integrally or otherwise connected to the second member 42. The upper handle portion 46 can be connected to the lower handle portion 48 opposite the curved handle end 50. For example, the upper handle portion 46 can be welded or otherwise connected to the lower handle portion 48, such as at a handle connection 52. The handle connection 52 can provide stability and strength to the apparatus. The upper handle portion 46 can extend past the handle connection 52 towards the first member 40 and can connect thereto. The upper handle portion 46 can be integrally connected or otherwise connected to the first member 40. The upper handle portion 46 can transmit forces exerted by a user holding the apparatus to the first member 40 and the second member 42 to provide a smooth and stable cutting and/or slicing movement.

The blade 10 is depicted engaged with the first member 40 and the second member 42. The frame can have a span 53. The span 53 can be configured, such as through sizing, to accommodate a variety of food products, such as shelf-stocked products, delicatessen prepared products, and other food products described herein. The blade 10 can be disposed within the span 53 and can pass therethrough.

FIG. 4 depicts a cut view of an embodiment of the apparatus shown in FIG. 3 along line A-A. The blade can be engaged within the frame, such as within a slot 54 disposed within the first member 40.

The cutting surface 24 can extend below the frame, such as below the first member 40 and the second member of the frame. In operation, when a food product is placed upon a surface, such as a countertop, for cutting, the extension of the cutting surface 24 below the frame can allow the cutting surface 24 to cut fully through the food product before the frame contacts the countertop.

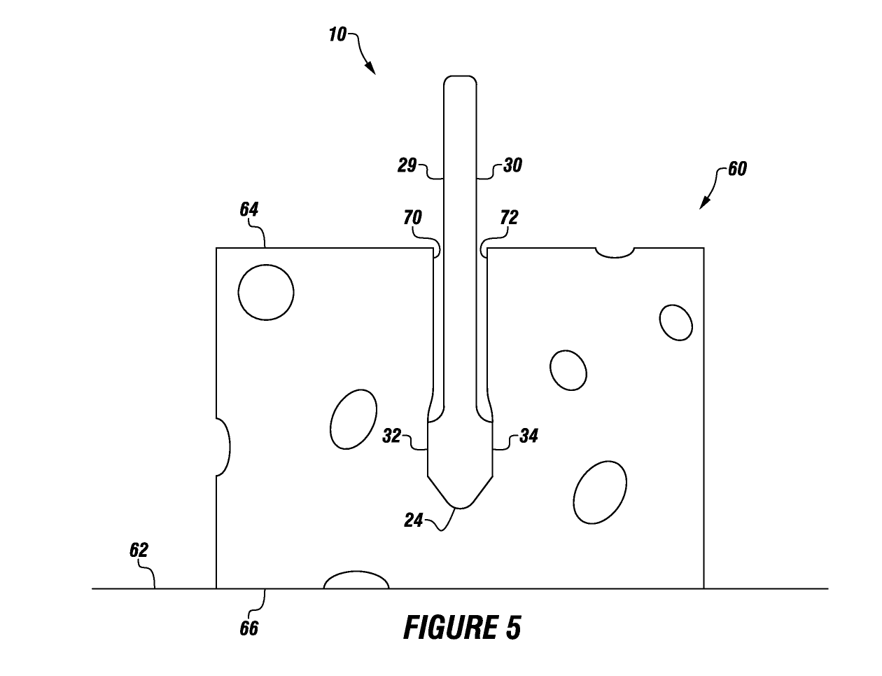

FIG. 5 depicts an embodiment of the apparatus during operation. A material to be cut, or a food product, here shown as cheese 60, is shown disposed on a surface, here shown as a countertop 62. The countertop 62 can be replaced with a cutting board or any other surface appropriate for cutting a material or a particular food product.

The cheese 60 has a top cheese surface 64 and a bottom cheese surface 66. The blade 10 is shown cutting and/or slicing through the cheese 60 from the top cheese surface 64 towards the bottom cheese surface 66 to the countertop 62.

In operation, as a user exerts force upon the blade 10, such as by exerting force upon a handle attached to the blade 10, the cutting surface 24 can pass through or traverse the cheese 60, forming a cutaway within the cheese 60.

As the cutting surface 24 traverses closer towards the bottom cheese surface 66, the portion of the cheese 60 that is already cut can contact the contact portion of the blade 10. For example, a first cut portion 70 of the cheese 60 is shown in contact with the first contact surface 32 and a second cut portion 72 of the cheese 60 is shown in contact with the second contact surface 34.

In operation of one or more embodiments, the cheese 60 will not contact the upper blade portion due to the thinner first thickness of the upper blade portion and the thicker second thickness of the contact portion. The first cut portion 70 will remain spaced apart from the first upper surface 29 and the second cut portion 72 will remain spaced apart from the second upper surface 30. As such, only a small portion of the blade 10, including the cutting surface 24, the first contact surface 32, and the second contact surface 34 will be in contact with the cheese 60 during cutting of the cheese 60. This configuration provides a minimal friction path for the cheese 60 by reducing the frictional contact surface of the blade 10 with the cheese 60 as opposed to if the upper blade portion were as thick as or thicker than the contact portion.

With the thinner upper blade portion and the thicker contact portion, the blade 10 has a minimal frictional path with food products; therefore, the occurrence of sticking or adherence of food products to the blade 10 is reduced and/or eliminated. Furthermore, the reduction of frictional contact between the food product and the blade 10 reduces the amount of force required of the user to cut and/or slice the food product using the blade, as there is less resistive frictional force to overcome. In one or more embodiments, the pressure required to cut a refrigerated block of cheese can be reduced from about forty percent to about sixty percent due to the reduced frictional contact between the cheese and the blade.

In embodiments with a frame, since the cutting surface 24 extends below the frame, the cutting surface 24 will contact the countertop 62, and therefore the blade 10 will cut fully from the top cheese surface 64 to the bottom cheese surface 66 before the frame can contact the countertop 62.

In one or more embodiments, the blade 10 can be utilized to cut and/or slice food products without requiring the user to use a sawing motion. The user can place the blade 10 on the top cheese surface 64 to cut and/or slice a desired thickness of cheese 60. The user can then exert a force upon the blade 10, such as by pressing straight downwards, to provide a clean and smooth cut and/or slice of the cheese 60.

While the present disclosure emphasizes the embodiments, it should be understood that within the scope of the appended claims, the disclosure might be embodied other than as specifically described herein.

What is claimed is:

1. A blade comprising:
a. an upper blade portion comprising a uniform first thickness;
b. a contact portion disposed on a bottom side of the upper blade portion, wherein the contact portion comprises a second thickness greater than the first thickness, and further wherein the contact portion extends laterally from the upper blade portion and steps down to the uniform first thickness of the upper blade portion; and
c. a cutting surface disposed on the contact portion opposite the upper blade portion, wherein the cutting surface shape comprises an arc of a circle from 1 degree to 180 degrees; and
wherein the blade is configured to be fixed on both ends such that there is substantially no flexion of the blade, and further wherein the blade is configured to be pushed through a material being cut.

2. The apparatus of claim 1, wherein the upper blade portion comprises a first upper surface and a second upper surface.

3. The apparatus of claim 1, wherein the upper blade portion comprises a height greater than a height of the contact portion.

4. The apparatus of claim 1, wherein the blade is straight and rigid.
